(19) United States
(12) Patent Application Publication
(10) Pub. No.: US 2010/0031568 A1
(43) Pub. Date: Feb. 11, 2010

(54) CONTAINER WATERING SYSTEM AND METHOD

(75) Inventor: Lee Burnett, Huntington Beach, CA (US)

Correspondence Address: K&L Gates LLP, P.O. BOX 1135, CHICAGO, IL, 60690, US

(73) Assignee: Lee Burnett, DO, APC, Sunset Beach, CA (US)

(21) Appl. No.: 12/189,385

(22) Filed: Aug. 11, 2008

(51) Int. Cl. A01G 9/02

(52) U.S. Cl. 47/66.1; 47/66.7

(57) ABSTRACT

A container watering system and method are provided. A gardening container can include an interior shell and an exterior shell. The interior shell includes an interior base and an interior wall. The exterior shell includes an exterior base and an exterior wall. The interior shell and exterior shell enclose a fill chamber. At least a portion of the fill chamber is between the interior base and the exterior base. The interior shell includes an interior opening that fluidicly couples the fill chamber with a volume partly enclosed by the interior wall. The exterior shell includes an exterior opening. The exterior opening is adjacent to the fill chamber.

### BACKGROUND

Plants are frequently grown in containers such as pots. Gardening in containers can enable a gardener to control the potting medium in which the plants grow, enable plants to be grown where the otherwise wouldn't be (e.g., inside, on patios, etc.), improve drainage and reduce exposure to pests and disease. However, gardening in containers can also expose plants to greater temperature changes. Further, container grown plants can be more susceptible to lack of water and to tipping over when bumped to blown by the wind, particularly if the plant in the container grows tall and leafy, moving up the center of mass and providing a lot of surface to catch the wind.

### SUMMARY

A container watering system and method are provided. In one embodiment, a gardening container includes an interior shell and an exterior shell. The interior shell includes an interior base and an interior wall. The exterior shell includes an exterior base and an exterior wall. The interior shell and exterior shell enclose a fill chamber. At least a portion of the fill chamber is between the interior base and the exterior base. The interior shell includes an interior opening that fluidicly couples the fill chamber with a volume partly enclosed by the interior wall. The exterior shell includes an exterior opening. The exterior opening is adjacent to the fill chamber.

In one embodiment, the gardening container also includes a connector. The connector enables a fluid delivery system to connect to the gardening container such that a fluid can be delivered by the delivery system through the exterior opening. In another embodiment, the connector includes a structure configured to secure a portion of the fluid delivery system to the gardening container.

In one embodiment, the exterior shell and the interior shell are coupled at a rim by heat fusion, glue, epoxy or a bonding or adhesive substance. In another embodiment, the exterior shell and the interior shell are formed by a single piece of material.

In one embodiment, the exterior opening is positioned below the interior base. In still another embodiment, the exterior shell and the interior shell are configured to form a drainage passage. The drainage passage is configured to enable an excess amount of fluid in the volume to exit the gardening container.

In one embodiment, a method of stabilizing a gardening container is provided. The method includes providing an interior shell and providing an exterior shell. The interior shell includes an interior base and an interior wall. The exterior shell includes an exterior base and an exterior wall. The interior shell and exterior shell enclose a fill chamber. At least a portion of the fill chamber is between the interior base and the exterior base. The interior shell includes an interior opening fluidicly coupling the fill chamber with a volume partly enclosed by the interior wall. The exterior shell includes an exterior opening. The exterior opening is adjacent to the fill chamber. The method also includes enabling the fill chamber to be substantially filled with a fluid.

In one embodiment, the method also includes providing a connector. The connector enables a fluid delivery system to connect to the gardening container such that the fluid can be delivered by the delivery system through the exterior opening. In another embodiment, the connector includes a structure configured to secure a portion of the fluid delivery system to the gardening container.

In one embodiment, the method includes coupling the exterior shell and the interior shell at a rim by heat fusion, glue, epoxy or a bonding or adhesive substance. In another embodiment, the method includes forming the exterior shell and the interior shell from a single piece of material.

In one embodiment, the exterior opening is positioned below the interior base. In another embodiment, the exterior shell and the interior shell are configured to form a drainage passage. The drainage passage is configured to enable an excess amount of fluid in the volume to exit the gardening container.

In another embodiment, a method of buffering a temperature of a potting medium in a gardening container is provided. The method includes providing an interior shell and providing an exterior shell. The interior shell includes an interior base and an interior wall. The exterior shell includes an exterior base and an exterior wall. The interior shell and exterior shell enclose a fill chamber. At least a portion of the fill chamber is between the interior base and the exterior base. The interior shell includes an interior opening fluidicly coupling the fill chamber with a volume partly enclosed by the interior wall. The exterior shell includes an exterior opening. The exterior opening is adjacent to the fill chamber. The method also includes enabling the fill chamber to be substantially filled with a fluid.

In one embodiment, the method also includes providing a connector. The connector enables a fluid delivery system to connect to the gardening container such that the fluid can be delivered by the delivery system through the exterior opening. In another embodiment, the connector includes a structure configured to secure a portion of the fluid delivery system to the gardening container.

In one embodiment, the method includes coupling the exterior shell and the interior shell at a rim by heat fusion, glue, epoxy or a bonding or adhesive substance. In another embodiment, the method includes forming the exterior shell and the interior shell from a single piece of material. In one embodiment, the exterior opening is positioned below the interior base.

Additional features and advantages are described herein, and will be apparent from, the following Detailed Description and the figures.

### BRIEF DESCRIPTION OF THE FIGURES

FIG. 1A is an exploded view of a gardening container in accordance with one embodiment.

FIG. 1B is a partial cross sectional view of the gardening container of FIG. 1A in accordance with one embodiment.

FIG. 2 is an exploded view of a gardening container shaped similarly to a dish or saucer sometimes placed under a pot to collect excess drainage water in accordance with one embodiment.

FIG. 2B is a partial cross sectional view of the gardening container of FIG. 2A in accordance with one embodiment.

### DETAILED DESCRIPTION

A container watering system and method are provided. In one embodiment, a container includes a fill chamber at its base. Further, the fill chamber can extend into the side wall of the container in a channel or in any other suitable manner. The fill chamber includes at least one exterior opening near the base of the container and at least one interior opening near the top of the container. Water and/or nutrient enriched water can be delivered to the fill chamber through the exterior opening by flexible tubing or any other suitable transport mechanism. The exterior opening can include a barbed connector which connects to the tubing. The barbed connector can extend from the container's side wall or recede into the side wall. Further, the connector is not required to be barbed, and can include any other structures for securing the tubing to the container, or can contain no structure for securing the tubing. In one embodiment, the tubing includes a barbed end or any other structure suitable for securing the tubing to the container.

Water is forced into the fill chamber (e.g., by a pump on a timer, by a gravity fed system, etc.), filling the fill chamber. Excess water exits the fill chamber through the interior openings. Preferably, the interior openings are above the top of the potting medium placed in the container. As a result, the gardener can see the amount of water being supplied to the potting medium. Further, by watering from above, the container enables gasses to be flushed through the potting medium. Preferably, the soil medium volume includes one or more drainage holes through or near the base, however such drainage holes are not required.

Filling the fill chamber with water lowers the center of mass of the container and plant combination, resulting in a more stable container. Further, having the exterior opening located near the base of the container further increases stability by keeping the water lines low (i.e., both below the center of mass, and below levels where they would more likely snare passing feet or other objects). Additionally, the water in the fill chamber helps stabilize potting medium temperatures. Water heats and cools more slowly than the air surrounding the container. As a result, the water in the fill chamber will heat more slowly as temperatures rise during the day, resulting in cooler potting medium temperatures at the hottest points of the day. Similarly, the water cools more slowly than the air, meaning the water will warm the potting medium in the coolest points of the night.

In various embodiments, two or more containers are connected in series or parallel. A first exterior opening of one container attaches to a water source (e.g., a drip irrigation system or any other irrigation system), and a second exterior opening connects via a water line to the first exterior opening of a second container. In such a manner, a plurality of containers can be “daisy chained” together, with the last container either having only one exterior opening or having a closed off second exterior opening or otherwise ensuring that water will fill each of the fill chambers.

Preferably, containers are configured to be stackable when empty; however, such stackability is not required. Further, containers can be any suitable shape or size, including cylindrical, squared, rectangular, or irregular.

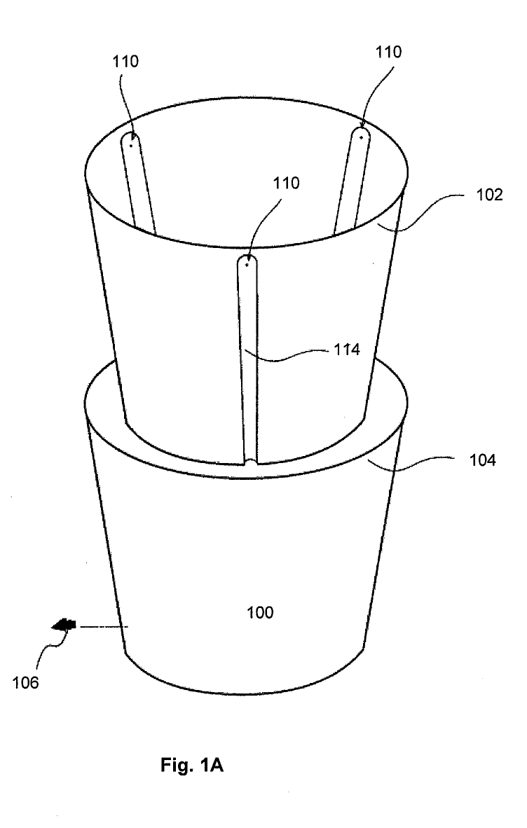

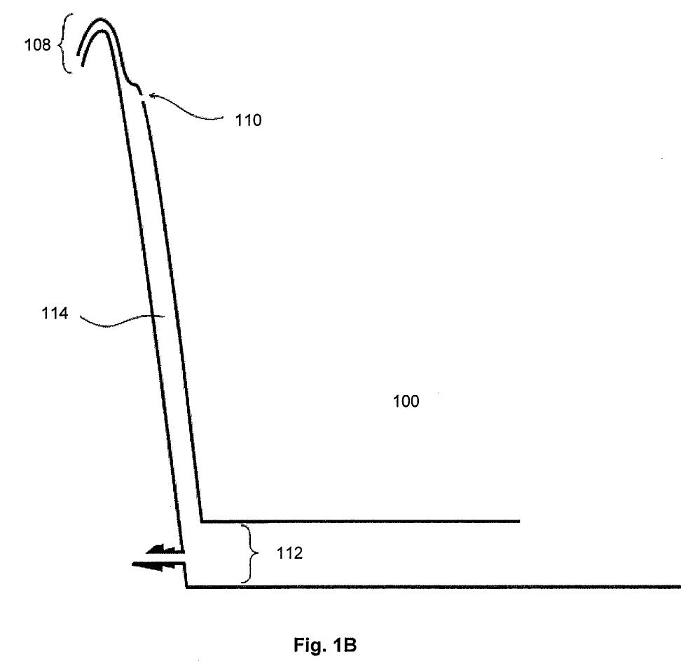

FIGS. 1A and 1B illustrate a container in accordance with one embodiment. The container 100 is shaped similarly to a standard pot. The container 100 includes an inner wall 102 and an outer wall 104. Preferably, the inner 102 and outer walls 104 are plastic; however, the walls can be any suitable material. Further, the walls are preferably joined by heat sealing, gluing, bonding with epoxy or in any other suitable manner at the top of the container (e.g., rim 108); however, the walls can be joined at any suitable location. Further, the walls can be blown or formed as one continuous piece of material, if desired.

A barbed connector 106 is positioned at an exterior opening in the exterior wall 104. Three interior openings 110 are positioned near rim 108 equidistantly around the container. Thus, water can be forced through connector 106 to fill the fill chamber 112. As the water level rises, water is forced into fill channels 114, which channel water to inner openings 110. Water can be supplied to connector 106 in any suitable manner, including via flexible tubing, pvc piping, metal piping, hosing, drip irrigation systems, timer and/or volume controlled water delivery systems, liquid nutrient delivery systems or any other suitable water delivery systems. The water delivery system can include a water temperature control device, but such a water temperature control device is not required.

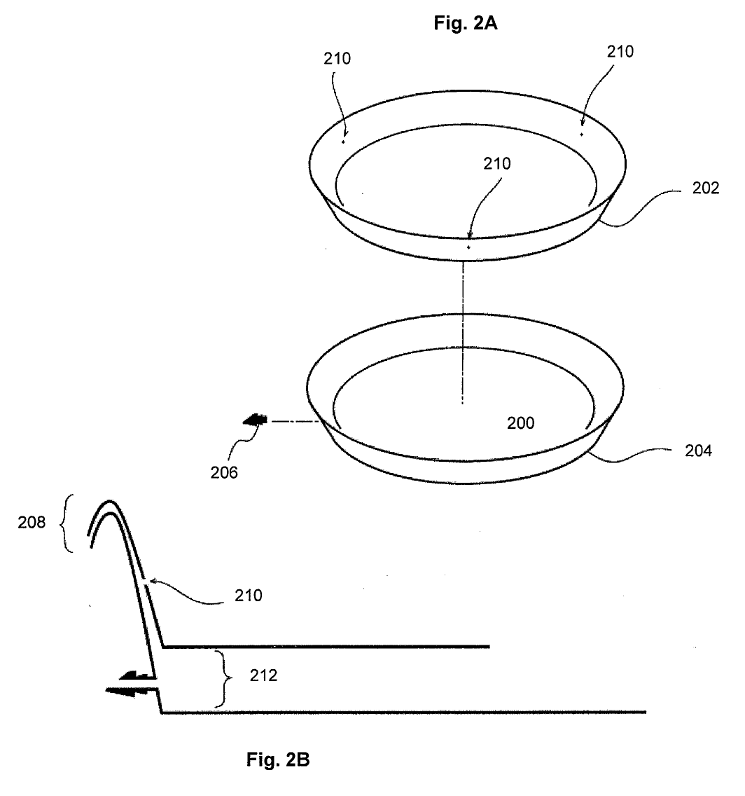

Typically, container 100 is nearly filled with a potting medium so that the upper level of the potting medium is below inner openings 10; however, in other embodiments, a container can house another container. For example, FIGS. 2A and 2B illustrate a container 200 shaped similarly to a dish or saucer sometimes placed under a pot to collect excess drainage water in accordance with one embodiment.

The container 200 includes an inner wall 202 and an outer wall 204. Preferably, the inner 202 and outer walls 204 are plastic; however, the walls can be any suitable material. Further, the walls are preferably joined by heat sealing, gluing, bonding with epoxy or in any other suitable manner at the top of the container (e.g., rim 208); however, the walls can be joined at any suitable location. Further, the walls can be blown or formed as one continuous piece of material, if desired.

A barbed connector 206 is positioned at an exterior opening in the exterior wall 204. Three interior openings 210 are positioned near rim 208 equidistantly around the container. Thus, water can be forced through connector 206 to fill the fill chamber 212. As the water level rises, water is forced into fill channels 214, which channel water to inner openings 210. Water can be supplied to connector 206 in any suitable manner, including via flexible tubing, pvc piping, metal piping, hosing, drip irrigation systems, timer and/or volume controlled water delivery systems, liquid nutrient delivery systems or any other suitable water delivery systems. The water delivery system can include a water temperature control device, but such a water temperature control device is not required.

Typically, a standard pot (e.g., a pot having one or more drainage openings at the base) is positioned in the interior of container 200. Thus, the gardener is able to view the flow rate of water being delivered to the pot in the container 200, and the pot is watered from its base by the water that pools in the interior of the container 200.

It should be understood that waste water that drains from the container in various embodiments and/or that flows through multiple containers in other embodiments can be re-circulated through the container again (e.g., after having its temperature and/or nutrient level adjusted).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gardening container comprising:
an interior shell including an interior base and an interior wall; and
an exterior shell including an exterior base and an exterior wall,
wherein the interior shell and exterior shell enclose a fill chamber, at least a portion of the fill chamber being between the interior base and the exterior base,
the interior shell including an interior opening fluidicly coupling the fill chamber with a volume partly enclosed by the interior wall,
the exterior shell including an exterior opening, the exterior opening being adjacent to the fill chamber.

2. The gardening container of claim 1, further comprising:
a connector, wherein the connector enables a fluid delivery system to connect to the gardening container such that a fluid can be delivered by the delivery system through the exterior opening.

3. The gardening container of claim 2, wherein the connector includes a structure configured to secure a portion of the fluid delivery system to the gardening container.

4. The gardening container of claim 1, wherein the exterior shell and the interior shell are coupled at a rim by heat fusion, glue, epoxy or a bonding or adhesive substance.

5. The gardening container of claim 1, wherein the exterior shell and the interior shell are formed by a single piece of material.

6. The gardening container of claim 1, wherein the exterior opening is positioned below the interior base.

7. The gardening container of claim 1, wherein the exterior shell and the interior shell are configured to form a drainage passage, the drainage passage being configured to enable an excess amount of fluid in the volume to exit the gardening container.

8. A method of stabilizing a gardening container comprising:
providing an interior shell including an interior base and an interior wall;
providing an exterior shell including an exterior base and an exterior wall,
wherein the interior shell and exterior shell enclose a fill chamber, at least a portion of the fill chamber being between the interior base and the exterior base,
the interior shell including an interior opening fluidicly coupling the fill chamber with a volume partly enclosed by the interior wall,
the exterior shell including an exterior opening, the exterior opening being adjacent to the fill chamber; and
enabling the fill chamber to be substantially filled with a fluid.

9. The method of claim 8, further comprising:
providing a connector, wherein the connector enables a fluid delivery system to connect to the gardening container such that the fluid can be delivered by the delivery system through the exterior opening.

10. The method of claim 9, wherein the connector includes a structure configured to secure a portion of the fluid delivery system to the gardening container.

11. The method of claim 8, further comprising:
coupling the exterior shell and the interior shell at a rim by heat fusion, glue, epoxy or a bonding or adhesive substance.

12. The method of claim 8, further comprising:
forming the exterior shell and the interior shell from a single piece of material.

13. The method of claim 8, wherein the exterior opening is positioned below the interior base.

14. The method of claim 8, wherein the exterior shell and the interior shell are configured to form a drainage passage, the drainage passage being configured to enable an excess amount of fluid in the volume to exit the gardening container.

15. A method of buffering a temperature of a potting medium in a gardening container comprising:
providing an interior shell including an interior base and an interior wall;
providing an exterior shell including an exterior base and an exterior wall,
wherein the interior shell and exterior shell enclose a fill chamber, at least a portion of the fill chamber being between the interior base and the exterior base,
the interior shell including an interior opening fluidicly coupling the fill chamber with a volume partly enclosed by the interior wall,
the exterior shell including an exterior opening, the exterior opening being adjacent to the fill chamber; and
enabling the fill chamber to be substantially filled with a fluid, the fluid having a specific heat approximately the same as the specific heat of water.

16. The method of claim 15, further comprising:
providing a connector, wherein the connector enables a fluid delivery system to connect to the gardening container such that the fluid can be delivered by the delivery system through the exterior opening.

17. The method of claim 16, wherein the connector includes a structure configured to secure a portion of the fluid delivery system to the gardening container.

18. The method of claim 15, further comprising:
coupling the exterior shell and the interior shell at a rim by heat fusion, glue, epoxy or a bonding or adhesive substance.

19. The method of claim 15, further comprising:
forming the exterior shell and the interior shell from a single piece of material.

20. The method of claim 15, wherein the exterior opening is positioned below the interior base.
